(19) United States
(12) Patent Application Publication
(10) Pub. No.: US 2013/0269851 A1
(43) Pub. Date: Oct. 17, 2013

(54) TIRE WITH MULTI-LAYERED BARRIER LAYER INNERLINER

(71) Applicant: Joseph Alan Incavo, The Woodlands, TX (US)

(72) Inventor: Joseph Alan Incavo, The Woodlands, TX (US)

(21) Appl. No.: 13/680,462

(22) Filed: Nov. 19, 2012

Related U.S. Application Data
(63) Continuation-in-part of application No. 13/444,910, filed on Apr. 12, 2012.

(51) Int. Cl. B60C 19/12

(52) U.S. Cl. CPC B60C 19/123
USPC 152/510

(57) ABSTRACT

The present invention is generally directed to pneumatic tires having a pre-formed multi-layered air barrier layer innerliner.

### FIELD OF THE INVENTION

The present invention is generally directed to pneumatic tires having a pre-formed multi-layered air barrier layer innerliner.

### BACKGROUND OF THE INVENTION

Conventionally, barrier layers, usually in a form of innerliners, for pneumatic rubber tires are comprised of butyl or halogenated butyl rubber (e.g. halobutyl rubber) layers which have greater resistance to air or oxygen permeability than other tire components. Such barrier layers, or innerliners, are provided to inhibit the loss of air or oxygen from the pneumatic tire cavity through the barrier layer into the tire carcass which promotes retention of air, including retention of air pressure, within the pneumatic tire cavity. In order to provide a suitable degree of air or oxygen impermeability, such innerliner layer needs to be sufficiently thick so that it adds significant weight to the tire. Further, an additional rubber layer, sometimes referred to as a tie layer, with low hysteresis loss, added in a manner that it is sandwiched between the barrier layer and the tire carcass.

The thickness of the butyl rubber (e.g. halobutyl rubber) adds significantly to the weight of the tire. Accordingly, alternate thinner materials with low air or oxygen permeability are desired, particularly in a form of thin films, for use as such barrier layers. Various candidates which are relatively impermeable to air or oxygen have heretofore been proposed, including, for example, polyvinylidene chloride, nylon, and polyester. For example, see U.S. Pat. Nos. 5,040,583, 4,928,741. Composites containing such films have been proposed such as, for example, at least one layer of a thin film of such non-elastomeric barrier material sandwiched and bonded between two elastomer layers of elastomeric compositions.

Thin films of alloys with a resistance to air and/or oxygen permeability have also been proposed for a tire innerliner layer comprised of a mixture of thermoplastic resin, elastomer and, optionally, a binder resin to enhance the compatibility between the thermoplastic resins and elastomers.

Advantageously, films of such low air/oxygen permeable alloys can be significantly thinner than their conventional butyl rubber-based counterpart tire innerliners and can therefore provide a substantial tire weight savings.

For this invention, however, is desired to provide a tire innerliner as a barrier to air and/or oxygen as a pre-formed multi-layered composite of a layered non-elastomeric film (e.g. nylon and/or polyester film), which does not contain an alloy of elastomer, bonded to at least one elastomeric composition layer together with an RFL based adhesive positioned between and in contact with said non-elastomeric film or layer of elastomeric composition of said multi-layered composite and a sulfur vulcanizable diene-based elastomer rubber of the tire carcass to promote adhering said multi-layered composite to said tire carcass.

### SUMMARY AND PRACTICE OF THE INVENTION

In accordance with this invention, a tire is provided which includes an assembly comprised of an outer circumferential tire tread, supporting fabric reinforced rubber carcass and pre-formed tire innerliner, (pre-formed in a sense of being formed or fabricated prior to application to an incurred tire component assembly), where said pre-formed innerliner is comprised of a multi-layered composite which promotes air impermeability together with an RFL adhesive layer positioned between said multi-layered composite and said tire carcass,

wherein said multi-layered composite is comprised of:
(A) film of nylon or polyethylene terephthalate polyester bonded to a layer of elastomer composition, which may be a sulfur vulcanizable rubber composition, or
(B) film of nylon of polyethylene terephthalate polyester sandwiched between two layers of an elastomer composition, which may be a sulfur curable rubber composition, elastomer based rubber composition, or
(C) a layer of elastomer composition, which may be a sulfur vulcanizable rubber composition, sandwiched between two films of nylon or polyethylene terephthalate polyester, or
(D) a layer of elastomer composition, which may be a sulfur curable rubber composition, sandwiched between a film of nylon a film of polyethylene terephthalate polyester;

wherein said RFL adhesive comprised of a resorcinol-formaldehyde resin/styrene-butadiene vinylpyridine latex or a blend thereof with a styrene-butadiene rubber latex, and is thereby in contact with an sulfur curable elastomer composition of said tire carcass and said nylon film, polyethylene terephthalate polyester or elastomer composition, which may be a sulfur vulcanizable rubber composition, layer of said multi-layered composite.

In practice, said RFL adhesive is a well known rescorcinol-formaldehyde resin/butadiene-styrene-vinyl pyridine terpolymer latex, or a blend thereof with a butadiene/styrene rubber latex, used in the tire industry for application to fabrics, fibers and textile cords for aiding in their adherence to rubber components (for example, see U.S. Pat. No. 4,356,219) although not understood as being applied to the multi-layered composite of this invention which is considered herein to be a significant departure from past practice.

In further accordance with this invention, said tire assembly is provided as a sulfur vulcanized composite vulcanized under conditions of elevated temperature and pressure.

In one embodiment, said nylon film and polyethylene terephthate polyester film do not contain a dispersion of (e.g. are exclusive of) elastomer such as example, sulfur vulcanizable, or sulfur vulcanized, elastomer.

In practice, said innerliner barrier composite is a pre-formed composite and the pre-formed composite built into the tire to form the uncured tire assembly of rubber components after which the tire assembly is vulcanized under conditions of elevated temperature and pressure in a suitable tire mold to form a tire comprised of integral components.

A significant aspect of this invention is the inclusion of the RFL adhesive positioned between and in contact with the surface of a sulfur vulcanizable elastomer based rubber composition of said tire carcass and:
(A) a surface of said nylon or polyethylene terephthalate polyester film of said multi-layered composite, or
(B) a surface of said rubber composition layer of said multi-layered composite.

This configuration of the pre-formed multi-layered composite is considered to be significant in a sense of enabling the composite to have suitable flexibility and elasticity for tire manufacturing processes and tire service under tire operating conditions while also providing a suitable barrier for air and/or oxygen.

Representative of sulfur vulcanizable elastomers of said tire carcass to which said RFL adhesive is in contact may be comprised of, for example, cis 1,4-polyisoprene, cis 1,4-polybutdiene and styrene/butadiene copolymer rubbers.

### BRIEF DESCRIPTION OF THE DRAWINGS

The figures (FIGS) contained in the accompanying drawings, which are incorporated in and constitute a part of this specification, are presented to illustrate several embodiments of the invention.

FIG. 1 is a cross-sectional view of a portion of pneumatic tire with an innerliner layer;

FIGS. 2, 3, 4 and 5 are enlarged partial cross-sectional views of the pneumatic tire of FIG. 1 taken along line 2-2 illustrating the tire innerliner layer as various multi-layered composites.

### THE DRAWINGS

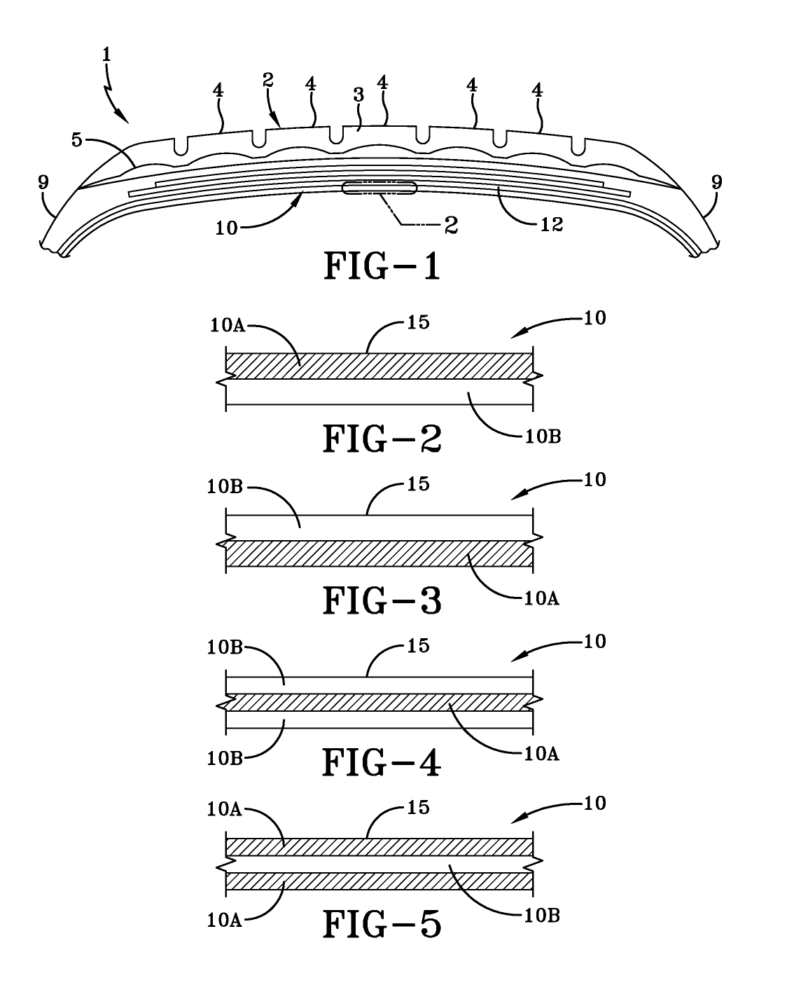

FIG. 1 depicts a section of a pneumatic tire (1) comprised of a tread (2) of a cap/base construction comprised of an outer tread cap rubber layer (3) with running surface (4) and an underlying tread base rubber layer (5), tread reinforcing belts (11) and supporting carcass with an inner vulcanizable elastomer-containing rubber layer (12), sidewalls (9) and innerliner, or barrier layer (10), as the innermost layer of the tire which is designed to inhibit the passage, or permeation, of air and oxygen through the barrier layer to promote air retention within the pneumatic tire cavity. The barrier layer (10), as is a conventional practice, does not contain an RFL adhesive coating.

FIG. 2 depicts an enlarged portion of the innerliner layer (10) as a composite of a thin nylon or polyethylene terephthalate film air/oxygen barrier layer (10A) bonded to an elastomer layer (10B), which may be a sulfur vulcanizable rubber composition . The innerliner layer composite (10) has an RFL coating (15) on the surface of the barrier film (10A) to bond the barrier film (10A), and thereby the innerliner layer composite (10) to the surface of the tire sulfur vulcanizable elastomer based rubber composition layer (12) of the tire carcass.

FIG. 3 depicts an enlarged portion of the innerliner layer (10) as a composite of a thin nylon or polyethylene terephthalate film air/oxygen barrier layer (10A) bonded to an elastomer layer (10B), which may be a sulfur vulcanizable rubber layer. The innerliner layer composite (10) has an RFL coating (15) on the surface of the elastomer layer (10B) to bond the elastomer layer (10B), and thereby the innerliner layer composite (10) to the surface of the tire sulfur vulcanizable elastomer based rubber composition layer (12) of the tire carcass.

FIG. 4 depicts an enlarged portion of the innerliner layer (10) as a composite of a thin nylon or polyethylene terephthalate film air/oxygen barrier layer (10A) bonded to and sandwiched between two elastomer layers (10B), which may be sulfur vulcanizable rubber layers. The innerliner layer composite (10) has an RFL coating (15) on the surface of an elastomer layer (10B) to bond the elastomer layer (10B), and thereby the innerliner layer composite (10) to the surface of the tire sulfur vulcanizable elastomer based rubber composition layer (12) of the tire carcass.

FIG. 5 depicts an enlarged portion of the innerliner layer (10) as a composite of an elastomer layer (10B), which may be a sulfur vulcanizable rubber layer, bonded to and sandwiched between two thin nylon or polyethylene terephthalate film air/oxygen barrier layers (10A). The innerliner layer composite (10) has an RFL coating (15) on the surface of a barrier film (10A) to bond the barrier film (10A), and thereby the innerliner layer composite (10) to the surface of the tire sulfur, vulcanizable elastomer based rubber composition layer (12) of the tire carcass.

Exemplary of the nylon film layer is, for example, nylon 6 or nylon 66, particularly nylon 6.

Polyvinylidinechloride is not desired because to it is unnecessarily subject to degradation in the presence of moisture for the innerliner barrier, and thereby the innerliner composite, of this invention as well as other polymeric films such as polyethylene and films of other polyolefins which have inadequate air impermeability as well as polyvinylchloride based films.

The thin polymeric film (nylon or polyethylene terephthalate polyester) for the barrier layer may have a film thickness, for example, from about 25 microns to about 200 microns. Alternatively, its thickness may range from about 50 microns to about 150 microns.

The aforesaid thin polymeric film for the barrier layer may have an oxygen permeability, for example, of less than 20×10⁻¹² cc-cm/cm²·sec·cmHg. Desirably, the aforesaid polymeric film for the barrier layer may also have an elongation, for example, of at least about 200 percent at about 23° C. As such, it is intended that, when used as the barrier layer of the tire, the polymeric film is not intended to break during the tire shaping process.

For the bonding of the innerliner, or barrier layer, composite to the tire carcass, the RFL adhesive is desired instead of other adhesive materials such as, for example, rosin-based resins; terpene-based resins; petroleum resins; cumarin-indene resins; styrene based resin other than said RFL adhesive; alkylphenol resins; a polyester polyol/isocyanate-type resins; an acrylic acid ester copolymer/organic peroxide-type resins; and reinforced polyurethane adhesive (RPU) resins.

The RFL adhesive may be applied to the innerliner composite by various methods including, for example, as spray coating, dip coating, or extrusion coating. The thickness of the RFL adhesive coating may be, for example, within the range from about 0.1 mil (about 2.5 microns) to about 10 mil (about 250 microns).

Where the innermost surface of the barrier layer film (10A) is exposed to the inner cavity of the tire, such as in FIG. 3 and in FIG. 5, its exposed surface may also include the RFL coating as a thin protective layer to, for example, promote scratch resistance for the innerliner composite.

The rubber compositions for the rubber tire carcass layer and the rubber layer for the innerliner composite can contain conventional rubber tire additives to provide a desired rubber property as would be applied by one having skill in the appropriate art. Such known and commonly used additive materials may include, for example, sulfur cure activators, retarders and accelerators, rubber processing oils, resins including tackifying resins, plasticizers, fatty acids, zinc oxide, waxes, antidegradant, antiozonants, and peptizing agents.

The uncured tire assembly can be molded and sulfur cured in a suitable tire mold at an elevated temperature and pressure conditions as would be appreciated and known to those having skill in such art.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention, its broader aspects, is therefore not limited to the specific details, representative apparatus and methods and illustrative examples shown and described. Accordingly, departures may be made from such details without departing from the scope or spirit of Applicant's general inventive concept.

What is claimed is:

1. A tire is provided as an assembly comprised of an outer circumferential tire tread, supporting fabric reinforced rubber carcass and tire innerliner, where said innerliner is comprised of a multi-layered composite which promotes air impermeability together with an RFL adhesive layer positioned between said multi-layered composite and said tire carcass, wherein said multi-layered composite is comprised of:
(A) film of nylon or polyethylene terephthalate polyester bonded to a layer of elastomer composition, or
(B) film of nylon of polyethylene terephthalate polyester sandwiched between two layers of an elastomer composition, or
(C) a layer of elastomer composition sandwiched between two films of nylon or polyethylene terephthalate polyester, or
(D) a layer of elastomer composition sandwiched between a film of nylon a film of polyethylene terephthalate polyester;
wherein said RFL adhesive is comprised of a resorcinol-formaldehyde resin/styrene-butadiene-vinylpyridine latex, or blend thereof with a styrene-butadiene rubber latex, and is thereby in contact with said sulfur vulcanizable rubber composition of said tire carcass and said nylon film, polyethylene terephthalate polyester or elastomer layer of said multi-layered composite.

2. The tire assembly of claim 1 wherein said elastomer layer of said multi-layered composite is a sulfur vulcanizable rubber composition.

3. The tire assembly of claim 1 wherein said nylon film and polyethylene terephthate polyester film are exclusive of an internal dispersion of elastomer.

4. The tire assembly of claim 2 wherein said nylon film and polyethylene terephthate polyester film are exclusive of an internal dispersion of elastomer.

5. The tire of claim 1 wherein said RFL adhesive coating is positioned between and in contact with the surface of said sulfur vulcanizable rubber layer of said tire carcass and:
(A) a surface of said nylon or polyethylene terephthalate polyester film of said multi-layered composite, or
(B) a surface of said elastomer layer of said multi-layered composite.

6. The tire of claim 2 wherein said RFL adhesive coating is positioned between and in contact with the surface of said sulfur vulcanizable rubber layer of said tire carcass and:
(A) a surface of said nylon or polyethylene terephthalate polyester film of said multi-layered composite, or
(B) a surface of said elastomer layer of said multi-layered composite.

7. The tire of claim 1 wherein said RFL adhesive coating is positioned between and in contact with the surface of said sulfur vulcanizable rubber layer of said tire carcass and a surface of said nylon or polyethylene terephthalate polyester film of said multi-layered composite.

8. The tire of claim 1 wherein said RFL adhesive coating is positioned between and in contact with the surface of said sulfur vulcanizable rubber layer of said tire carcass and a surface of said elastomer layer of said multi-layered composite.

9. The tire of claim 1 wherein said RFL adhesive coating is comprised of a resorcinol-formaldehyde resin/styrene-butadiene-vinylpyridine latex.

10. The tire of claim 1 wherein said RFL adhesive coating is comprised of a blend of resorcinol-formaldehyde resin/styrene-butadiene-vinylpyridine latex and a styrene-butadiene rubber latex.

11. The tire assembly of claim 1 as a sulfur vulcanized composite.

12. The tire assembly of claim 2 as a sulfur vulcanized composite.

13. The tire assembly of claim 3 as a sulfur vulcanized composite.

14. The tire assembly of claim 4 as a sulfur vulcanized composite.

15. The tire assembly of claim 5 as a sulfur vulcanized composite.

16. The tire assembly of claim 6 as a sulfur vulcanized composite.

17. The tire assembly of claim 7 as a sulfur vulcanized composite.

18. The tire assembly of claim 8 as a sulfur vulcanized composite.

19. The tire assembly of claim 9 as a sulfur vulcanized composite.

20. The tire assembly of claim 10 as a sulfur vulcanized composite.
